(19) United States
(12) Patent Application Publication
(10) Pub. No.: US 2023/0305266 A1
(43) Pub. Date: Sep. 28, 2023

(54) OPTICAL APPARATUS, CONTROL METHOD, AND STORAGE MEDIUM

(71) Applicant: CANON KABUSHIKI KAISHA, Tokyo (JP)

(72) Inventor: Ryota SEKIMOTO, Tokyo (JP)

(21) Appl. No.: 18/184,126

(22) Filed: Mar. 15, 2023

(30) Foreign Application Priority Data
Mar. 23, 2022 (JP) 2022-046291

(51) Int. Cl. G02B 7/36

(52) U.S. Cl. CPC G02B 7/36; G02B 7/14

(57) ABSTRACT

An optical apparatus includes a first optical system and a second optical system arranged in parallel, a first optical member provided to the first optical system and drivable, a second optical member provided to the second optical system, and having the same function as that of the first optical member, and a control unit configured to control driving of the first and second optical members so as to provide a difference between driving positions of the first and second optical members.

### BACKGROUND

### Technical Field

One of the aspects of the disclosure relates to an optical apparatus having two optical systems arranged in parallel.

### Description of the Related Art

High dynamic range (HDR) image data can be acquired by combining underexposure image data and overexposure image data. The conventional method for acquiring underexposure image data and overexposure image data from consecutive imaging can acquire HDR still image data but has difficulty in acquiring HDR moving (or motion) image data.

Japanese Patent No. 5574792 discloses a method for acquiring frame image data by consecutive imaging three times with proper exposure, underexposure, and overexposure by changing ISO speed in moving image capturing, and for acquiring HDR moving image data including frame image obtained by combining these three frame image data.

The method disclosed in Japanese Patent No. 5574792 acquires three frame image data with different exposures by plural imaging, and thus the frame rate of the combined HDR moving data is lower than that of moving data acquired by normal imaging.

### SUMMARY

One of the aspects of the embodiment provides an optical apparatus that can acquire a plurality of moving image data to be combined with one another without lowering the frame rate of the combined moving image data.

An optical apparatus according to one aspect of the disclosure includes a first optical system and a second optical system arranged in parallel, a first optical member provided to the first optical system and drivable, a second optical member provided to the second optical system, and having the same function as that of the first optical member, at least one processor, and a memory coupled to the at least one processor and storing instructions that, when executed by the processor, cause the at least one processor to function as a control unit configured to control driving of the first and second optical members so as to provide a difference between driving positions of the first and second optical members. A control method corresponding to the optical apparatus and a storage medium storing a program for causing a computer to execute the above control method also constitute another aspect of the disclosure.

Further features of the disclosure will become apparent from the following description of embodiments with reference to the attached drawings. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

### BRIEF DESCRIPTION OF THE DRAWINGS

FIG. 1 is a block diagram illustrating a configuration of a camera system including an interchangeable lens according to an embodiment.

FIG. 2 is a flowchart illustrating processing according to the embodiment.

FIG. 3 explains an F-number (or aperture value) setting and focus operation in the embodiment.

FIG. 4 is a flowchart illustrating focus processing in the embodiment.

### DESCRIPTION OF THE EMBODIMENTS

Referring now to the accompanying drawings, a description will be given of embodiments according to the disclosure.

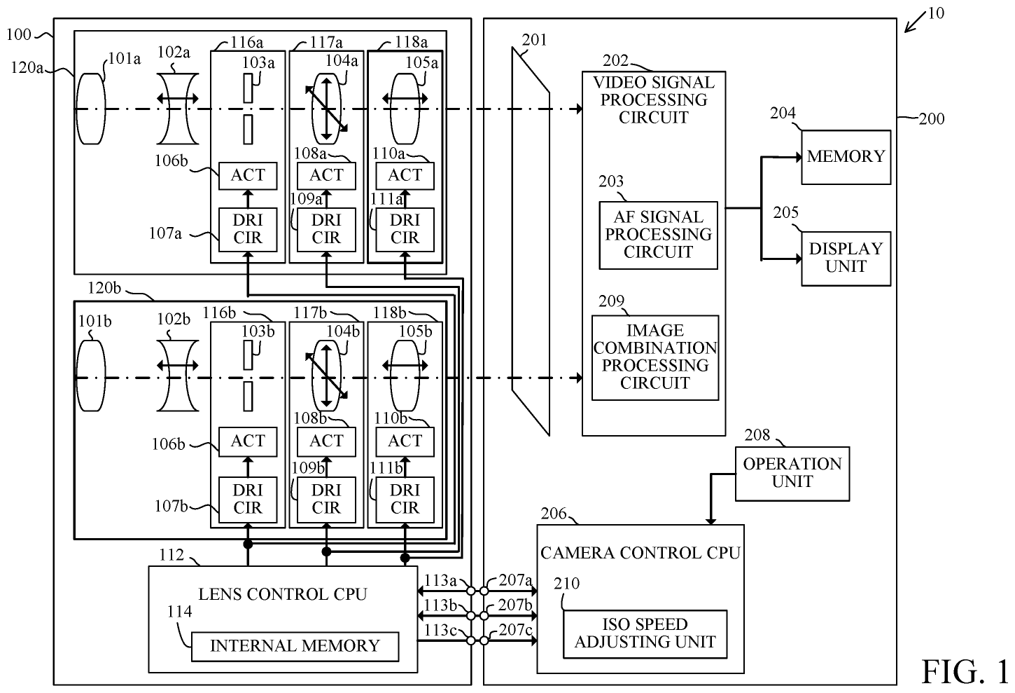

FIG. 1 illustrates a camera system (imaging system) 10 that includes a lens apparatus (referred to as an interchangeable lens hereinafter) 100 as an optical apparatus according to one embodiment of the disclosure and an image pickup apparatus (referred to as a camera body hereinafter) 200 to which the interchangeable lens 100 is detachably and communicatively attached.

The interchangeable lens 100 is a double-lens type interchangeable lens that includes a first optical system 120a and a second optical system 120b arranged in parallel. The first optical system 120a includes, in order from an object side to an image side, a fixed front lens unit 101a, a magnification varying lens unit 102a, an aperture stop (diaphragm) 103a, a correction lens unit 104a, and a focus lens unit 105a. Each lens unit is illustrated as a single lens in FIG. 1, but actually includes one or more lenses.

The magnification varying lens unit 102a is moved in the optical axis direction in a case where an unillustrated zoom ring provided to the interchangeable lens 100 is rotated. Thereby, a distance between adjacent lens units in the first optical system 120a varies, and zooming is performed from a wide-angle end to a telephoto end. The magnification varying lens unit 102a may be driven in the optical axis direction by a zoom actuator such as a stepping motor or a DC motor.

The aperture stop 103a is driven by an aperture actuator 106a that includes a stepping motor, a DC motor, or the like configured to change an aperture diameter (F-number or aperture value). An aperture driving circuit 107a supplies a driving signal to the aperture actuator 106a to drive it. A light amount adjusting unit 116a includes the aperture stop 103a, the aperture actuator 106a, and the aperture driving circuit 107a.

The correction lens unit 104a is driven in a shift direction orthogonal to the optical axis (illustrated by an alternate long and short dash line) by an image stabilizing actuator 108a such as a stepping motor or a voice coil motor to reduce (correct) image blurring caused by camera shake such as manual shake. An image stabilizing driving circuit 109a supplies a driving signal to the image stabilizing actuator 108a. The image stabilizing unit 117a includes the correction lens unit 104a, the image stabilizing actuator 108a, and the image stabilizing driving circuit 109a.

The focus lens unit 105a is driven by a focus actuator 110a that includes a stepping motor, a voice coil motor, a vibrating motor, etc., and is moved in the optical axis direction for focusing that makes the focus state closer to the in-focus state. A focus driving circuit 111a supplies a driving signal to the focus actuator 110a. The focusing unit 118a includes the focus lens unit 105a, the focus actuator 110a, and the focus driving circuit 111a. Those elements in the second optical system 120b are designated by corresponding reference numerals by replacing “a” with “b” for the elements in the first optical system 120a. The aperture stop 103a and the focus lens unit 105a in the first optical system 120a correspond to a drivable first optical member. The aperture stop 103b and the focus lens unit 105b in the second optical system 120b are optical members having the same functions as those of the aperture stop 103a and the focus lens unit 105a, respectively, and correspond to a second optical member.

After the interchangeable lens 100 is attached to the camera body 200, unillustrated power contact and communication contacts 113a, 113b, and 113c provided to the interchangeable lens 100 are connected to unillustrated power contact and communication contacts 207a, 207b, and 207c provided to the camera body 200, respectively. The power contact connection enables power to be supplied the interchangeable lens 100 from an unillustrated secondary battery such as a lithium—ion battery in the camera body 200. The communication contacts connections enable various information to be communicated between a lens control CPU (control unit) 112 in the interchangeable lens 100 and a camera control CPU 206 in the camera body 200. FIG. 1 illustrates a three-wire type serial communication, but another communication method may be used for communication.

The camera body 200 includes an image sensor 201 that includes a photoelectric conversion element such as a CCD sensor and a CMOS sensor. The image sensor 201 photoelectrically converts optical images (object images) formed by the first optical system 120a and the second optical system 120b on its imaging plane. More specifically, the light passing through the first optical system 120a forms an optical image on the right side of the image sensor 201, and the light passing through the second optical system 120b forms an optical image on the left side of the image sensor 201. Thereby, two optical images can be imaged by the image sensor 201 without interference between the light passing through the first optical system 120a and the light passing through the second optical system 120b. The charges accumulated in the image sensor 201 are read out as an analog imaging signal at a predetermined timing and input to a video signal processing circuit 202.

The video signal processing circuit 202 as an image processing unit converts the analog imaging signal read out of the image sensor 201 into a digital imaging signal, performs various signal processing such as amplification and gamma correction for the digital imaging signal, and generates a digital video signal (moving image data). The digital video signal is output to the camera control CPU 206, a display unit 205 that includes a liquid crystal display panel or the like, and a memory 204 that includes an optical disc, a semiconductor memory, or the like.

An autofocus (AF) signal processing circuit 203 is provided in the video signal processing circuit 202. The AF signal processing circuit 203 extracts a high-frequency component and a luminance component obtained from pixels within an AF area as a focus detecting area, from the digital imaging signal (or digital video signal), and generates a focus evaluation value signal as focus information. The focus evaluation value signal indicates an image contrast state (imaging contrast), that is, the sharpness, and changes as the focus lens units 105a and 105b move. A value of the focus evaluation value signal, that is, a focus position at which the focus evaluation value becomes maximum (peak) is an in-focus position of the AF area.

An image combination processing circuit 209 is provided in the video signal processing circuit 202. The image combination processing circuit 209 performs specific processing for the digital video signal obtained from the output from the image sensor 201 and converts the digital video signal into a moving image that is compatible with the VR180 video format with an angle of view of 180°. The optical axis of the first optical system 120a and the optical axis of the second optical system 120b are separated from each other by a baseline length in the direction orthogonal to these optical axes, and the video signals acquired through the first optical system 120a and the second optical system 120b has a parallax. Using this parallax can generate a VR180 moving image that provides stereoscopic viewing. Observing the VR180 moving image through an observation apparatus such as a head mount display, the user can view a stereoscopic image.

The image combination processing circuit 209 can separately convert a plurality of video signals obtained through the first optical system 120a and the second optical system 120b into VR180 format video signals, combine these video signals, and thereby acquire a VR180 moving image as the same video signal having no parallax. For example, overexposure video signals and underexposure video signals may be generated through the first optical system 120a and the second optical system 120b, respectively, and these video signals may be combined to generate HDR moving image data. The image combination processing circuit 209 is not necessarily built into the camera body 200 and may be disposed outside the camera body 200.

The lens control CPU 112 includes an internal memory 114. The internal memory 114 stores table data indicating a focus moving amount against an aperture narrowing amount from the open position in a case where the aperture actuators 106a and 106b are driven.

The camera control CPU 206 includes an ISO speed adjusting unit 210. The ISO speed adjusting unit 210 is provided in the camera control CPU 206 and determines the ISO speed. The ISO speed adjusting unit 210 determines the ISO speed based on an output value of an unillustrated photometry unit (AE) that measures a light amount received from an object.

An operation unit 208 includes an operation member such as a plurality of buttons and dials. The ISO speed, shutter speed, and F-number, which determine the exposure condition during imaging, can be set by pressing a button or rotating a dial of the operation unit 208. The camera body 200 includes operation members for setting an imaging mode, instructing imaging, setting an HDR effect amount, and the like.

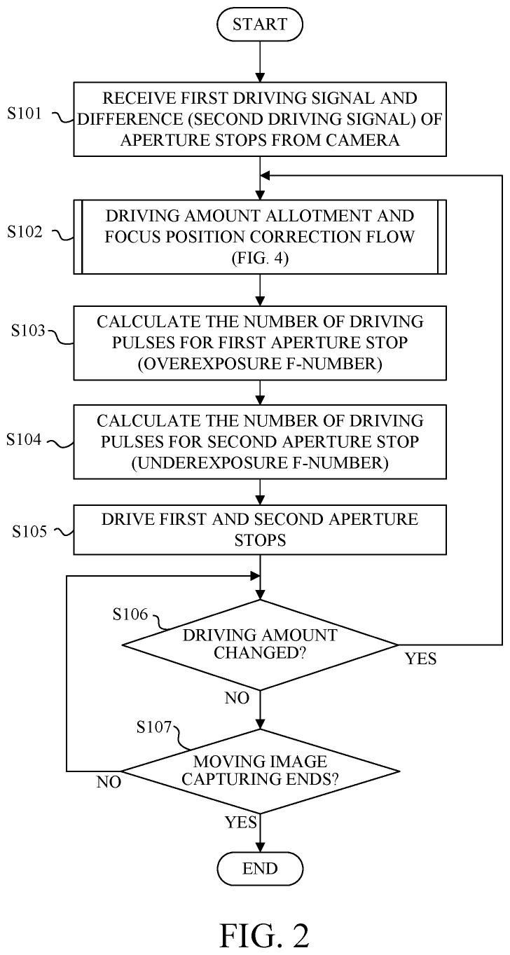

FIG. 2 illustrates the processing (control method) executed by the lens control CPU 112 in capturing a moving image. The lens control CPU 112 executes this processing according to a computer program. In this embodiment, the lens control CPU 112 in the interchangeable lens 100 executes this processing, but a CPU in a lens-integration type image pickup apparatus (optical apparatus) may execute this processing. That is, the embodiment of the disclosure is applicable not only to the lens apparatus but also to the lens-integration type image pickup apparatus.

In step S101, the lens control CPU 112 communicates with the camera control CPU 206 to receive a first driving amount and a second driving amount for the aperture stops (first aperture stop, second aperture stop) 103a and 103b. The driving amount of the aperture stop herein is a driving amount from the open position as a reference position of the aperture stop, and can be rephrased as an F-number as a driving position. The first and second driving amounts may be directly input by the user in the camera body 200, or may be determined by the camera control CPU 206 based on the HDR effect amount specified by the user. Thus, the lens control CPU 112 accepts input of information on the first and second driving amounts (driving positions having a difference from each other). The information about the first and second driving amounts may be the first and second driving amounts themselves, or information that can be converted into the first and second driving amounts.

To which of the aperture stops 103a and 103b each of the first and second driving amounts is allotted is determined in the next step S102. As for the second driving amount, the lens control CPU 112 may receive the second driving amount itself, or may receive a difference from the first driving amount. Now assume that the lens control CPU 112 receives the first driving amount and also receives the difference from the first driving amount as the second driving amount.

The difference between the first and second driving amounts is proportional to the HDR effect amount in the HDR moving image data obtained by the image combination. This is because the larger the difference between the driving amounts of the aperture stops 103a and 103b is, the larger the contrast difference between two optical images formed by the first optical system 120a and the second optical system 120b becomes and the larger the contrast difference (that is, the HDR effect amount) between two moving image data corresponding to these optical images becomes.

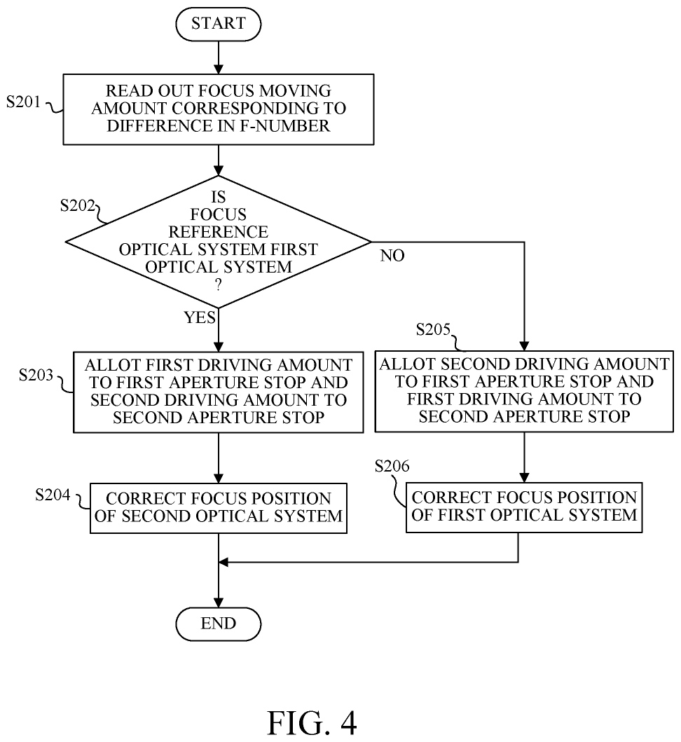

In step S102, the lens control CPU 112 determines to which of the aperture stops 103a and 103b each of the first and second driving amounts is allotted. At this time, the lens control CPU 112 also corrects the position of the focus lens unit 105a or the focus lens unit 105b, as described below with reference to FIG. 4.

In step S103, the lens control CPU 112 calculates the driving amount (first or second driving amount) for the aperture stop 103a. In order to obtain HDR moving image data by the subsequent image combination, the driving amount of the aperture stop 103a is set so as to provide underexposure or overexposure against the proper exposure. In this example, the lens control CPU 112 calculates the driving amount for the aperture stop 103a so as to provide an overexposure F-number.

In step S104, the lens control CPU 112 calculates the driving amount (second or first driving amount) for the aperture stop 103b. In this example, the lens control CPU 112 calculates the driving amount for the aperture stop 103b so as to provide an underexposure F-number.

In step S105, the lens control CPU 112 drives the aperture stops 103a and 103b with the driving amounts calculated in steps S103 and S104 to change their aperture diameters. Thus, an overexposure optical image and an underexposure optical image are formed on the image sensor 201 by the light beams passing through the aperture stops 103a and 103b.

In step S106, the lens control CPU 112 communicates with the camera control CPU 206 to determine whether or not there is a change in the first driving amount and the second driving amount (difference from the first driving amount) for the aperture stops 103a and 103b. In a case where there is a change, the flow returns to step S102, and in a case where there is no change, the flow proceeds to step S107. The first and second driving amounts change, for example, in a case where the luminance of the object changes during moving image capturing, and in a case where the setting of the exposure condition or the HDR effect amount is changed by the user operation. In a case where the luminance of the object changes, the first and second driving amounts similarly change and the difference between them does not change. On the other hand, in a case where the setting of the exposure condition or the HDR effect amount is changed, the difference between the first and second driving amounts changes.

A description will now be given of an HDR video imaging effect by making the driving amounts (F-numbers) for the aperture stops 103a and 103b different from each other. This embodiment provides a difference between the driving amounts for the aperture stops 103a and 103b without using a neutral density (ND) filter, and makes different exposures of two video signals acquired by imaging through the first and second optical systems 120a and 120b. As described above, the HDR effect amount is proportional to the difference between the driving amounts for the aperture stops 103a and 103b. Unlike the ND filter, which requires attachment work before imaging to the interchangeable lens 100 and has a fixed light attenuation amount, the aperture stops 103a and 103b do not require attachment work before imaging, and a driving amount difference between them is variable during moving image capturing. Therefore, this embodiment can dynamically change the HDR effect amount during moving image capturing and provide a wider variety of visual expressions than ever.

In step S107, the lens control CPU 112 communicates with the camera control CPU 206 to determine whether or not moving image capturing has ended. In a case where the imaging has not yet ended, the flow returns to step S106, and the change in the driving amount difference between the aperture stops 103a and 103b according to the user operation is continued until the moving image imaging ends in step S107. In a case where the moving image capturing is completed, this flow ends.

Thus, the overexposure video signal (first moving image data) obtained through the first optical system 120a and the underexposure video signal (second moving image data) obtained through the second optical system 120b are combined and converted into HDR moving image data by the image combination processing circuit 209.

The two video signals obtained through the first and second optical systems 120a and 120b do not necessarily have to be overexposure and underexposure video signals, as long as there is an exposure difference that allows HDR moving image data to be combined. For example, overexposure and proper exposure video signals may be used.

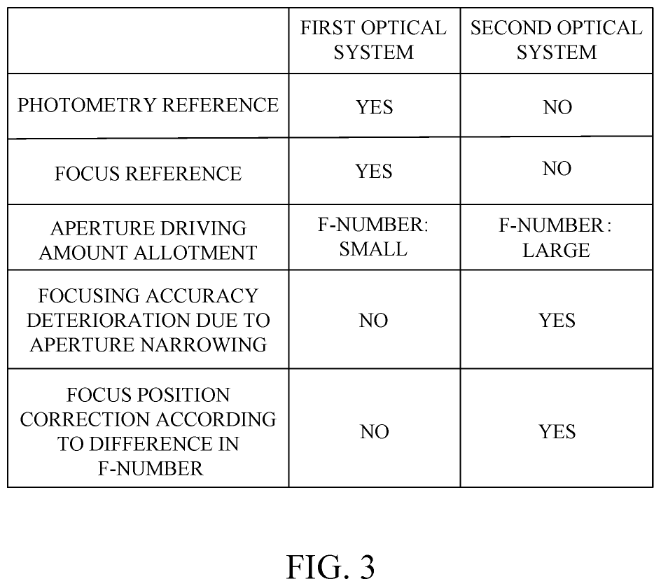

Referring now to FIGS. 3 and 4, a description will be given of the allotment of F-numbers to the first and second optical systems 120a and 120b and focusing operation in this embodiment. This embodiment sets different F-numbers to the first and second optical systems 120a and 120b, and thus there is a difference in depth of field between the first and second optical systems 120a and 120b.

In general, focusing that drives the focus lens in the optical system has a characteristic in that the shallower the depth of field is, the better the focusing accuracy becomes. Therefore, focusing may be performed in one of the first and second optical systems 120a and 120b that has a smaller F-number and thus a shallower depth of field.

In a case where the F-numbers of the two optical systems are different from each other, which optical system should be used for photometry may be determined. If the optical system that provides focusing is different from the optical system that provides photometry among the two optical systems, the accuracies of the photometry and focusing deteriorate.

This embodiment can maintain good photometry accuracy and focusing accuracy by allocating a smaller F-number to the optical system that serves as a reference for focusing (referred to as a focus reference optical system hereinafter) among the first and second optical systems 120a and 120b.

A description will now be given of correction of the focus lens position (focus position) against the F-number. In general, a change in F-number shifts focus, and changes the in-focus position. If a focus position of an optical system that is not used as a reference for focusing (referred to as a non-focus-reference optical system hereinafter) among the two optical systems is set equal to that of the focus reference optical system, a difference in F-number between the two optical systems deteriorates the focusing accuracy of the non-focus reference optical system.

Thus, this embodiment previously stores as data focus moving amounts against the driving amounts of the aperture stops 103a and 103b (change in F-number). This embodiment corrects the focus position of the non-focus-reference optical system according to the driving amount difference between the aperture stop in the non-focus-reference optical system and the aperture stop in the focus reference optical system. Thereby, this embodiment can prevent the focusing accuracy of the non-focus-reference optical system from deteriorating.

FIG. 3 summarizes the above discussion in a table. This embodiment sets the first optical system 120a to a photometry reference optical system that performs photometry and a focus reference optical system, and allots a driving amount to the aperture stop 103a such that the F-number of the aperture stop 103a is smaller than that of the aperture stop 103b in the second optical system 120b. This embodiment corrects the focus position of the non-focus-reference optical system according to the difference in F-number from the focus reference optical system.

A flowchart in FIG. 4 illustrates the processing for allotting F-numbers to the aperture stops 103a and 103b and for correcting the focus position of the non-focus-reference optical system.

In step S201, the lens control CPU 112 reads out focus moving amount data against a change in F-number stored in the internal memory 114, and calculates a focus moving amount caused by a difference in F-number between the aperture stops 103a and 103b.

In step S202, the lens control CPU 112 determines whether or not the focus reference optical system is the first optical system 120a. If so, the flow proceeds to step S205.

In step S203, the lens control CPU 112 allots the first driving amount to the aperture stop 103a in the first optical system 120a as the focus reference optical system, and the second driving amount to the aperture stop 103b in the second optical system 120b as the non-focus-reference optical system. The F-number obtained with the first driving amount is smaller than the F-number obtained with the second driving amount. The number of driving pulses is calculated in steps S103 and S104 of FIG. 2 according to this allocation of the driving amounts.

In step S204, the lens control CPU 112 corrects the focus position of the second optical system 120b. More specifically, the lens control CPU 112 calculates the driving amount for the focus lens unit 105b based on the focus moving amount calculated in step S201, and controls the focus driving circuit 111b so that the focus lens unit 105b is moved by the driving amount. Then, the lens control CPU 112 ends this flow.

On the other hand, in step S205, the lens control CPU 112 allots the first driving amount to the aperture stop 103b in the second optical system 120b as the focus reference optical system, and the second driving amount to the aperture stop 103a in the first optical system 120a as the non-focus-reference optical system. Again, the F-number obtained with the first driving amount is smaller than the F-number obtained with the second driving amount.

In step S206, the lens control CPU 112 corrects the focus position of the first optical system 120a. More specifically, the lens control CPU 112 calculates the driving amount for the focus lens unit 105a based on the focus moving amount calculated in step S201, and controls the focus driving circuit 111a so that the focus lens unit 105a is moved by the driving amount. Then, the lens control CPU 112 ends this flow.

This embodiment makes different the F-numbers for the first and second optical systems 120a and 120b and thereby acquires two video data with different exposures at the same time. Thus, this embodiment can obtain two moving image data to be combined with each other without reducing the frame rate of the combined HDR moving image data.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-046291, filed on Mar. 23, 2022, which is hereby incorporated by reference herein in its entirety.

What is claimed is:

1. An optical apparatus comprising:
a first optical system and a second optical system arranged in parallel;
a first optical member provided to the first optical system and drivable;
a second optical member provided to the second optical system, and having the same function as that of the first optical member;
at least one processor; and
a memory coupled to the at least one processor and storing instructions that, when executed by the at least one processor, cause the at least one processor to function as:
a control unit configured to control driving of the first and second optical members so as to provide a difference between driving positions of the first and second optical members.

2. The optical apparatus according to claim 1, wherein the control unit receives input of information on the driving positions of the first and second optical members having the difference from each other, and controls the driving according to the information.

3. The optical apparatus according to claim 1, wherein the control unit changes the difference during moving image capturing.

4. The optical apparatus according to claim 1, wherein the first and second optical members include aperture stops whose F-numbers change according to the driving positions.

5. The optical apparatus according to claim 4, wherein in a case where one of the first and second optical systems is a focus reference optical system that serves as a reference for focusing, and the other is a non-focus-reference optical system, the control unit sets the driving positions such that the F-number of the aperture stop in the focus reference optical system is smaller than the F-number of the aperture stop in the non-focus-reference optical system.

6. The optical apparatus according to claim 5, wherein the control unit acquires data on a focus moving amount against a change in F-number of each aperture stop, and corrects a position of a focus lens unit in the non-focus-reference optical system based on the data.

7. The optical apparatus according to claim 1, wherein the optical apparatus is a lens apparatus attachable to and detachable from an image pickup apparatus.

8. The optical apparatus according to claim 1, wherein the optical apparatus is an image pickup apparatus including an image sensor for imaging and an image processing unit, and
wherein the image processing unit combines first moving image data generated by imaging through the first optical system and second moving image data generated by imaging through the second optical system, and generates moving image data with a wider dynamic range than that of each of the first and second moving image data.

9. A control method for an optical apparatus that includes a first optical system and a second optical system arranged in parallel, a first optical member provided to the first optical system and drivable, and a second optical member provided to the second optical system, and having the same function as that of the first optical member, the control method comprising controlling driving of the first and second optical members so as to provide a difference between driving positions of the first and second optical members.

10. A non-transitory computer-readable storage medium storing a program for causing a computer to execute the control method according to claim 9.
